(19) United States
(12) Patent Application Publication
(10) Pub. No.: US 2025/0291096 A1
(43) Pub. Date: Sep. 18, 2025

(54) VIRTUAL IMAGE DISPLAY DEVICE

(71) Applicant: SEIKO EPSON CORPORATION, Tokyo (JP)

(72) Inventors: Takashi TAKEDA, SUWA-SHI, NAGANO-KEN (JP); Masayuki TAKAGI, AZUMINO-SHI, NAGANO-KEN (JP)

(73) Assignee: SEIKO EPSON CORPORATION, Tokyo (JP)

(21) Appl. No.: 19/077,041

(22) Filed: Mar. 11, 2025

(30) Foreign Application Priority Data
Mar. 13, 2024 (JP) 2024-038752

(51) Int. Cl. G02B 5/30

(52) U.S. Cl. CPC G02B 5/3016; G02B 5/3058

(57) ABSTRACT

A virtual image display device includes a first lens formed of a curved surface protruding toward a display element emitting image light, a second lens formed of a curved surface protruding toward the display element, a first polarizing layer formed along a curved surface on the second lens, and transmitting a first polarized ray and reflect a second polarized ray, a second polarizing layer transmitting the first polarized ray, a first wavelength layer formed along a curved surface on the first lens, and imparting a phase difference to incident light and transmit the incident light, a reflection layer transmitting a part of incident light and reflecting a remaining part of the incident light, and a second wavelength layer formed along the curved surface on the first lens, and imparting a phase difference to incident light and transmit the incident light.

The present application is based on, and claims priority from JP Application Serial Number 2024-038752, filed Mar. 13, 2024, the disclosure of which is hereby incorporated by reference herein in its entirety.

### BACKGROUND

### 1. Technical Field

The present disclosure relates to a virtual image display device.

### 2. Related Art

A virtual image display device capable of making a virtual image observable by guiding image light emitted from a display element to an observer's eye by means of an optical element such as a lens is traditionally known. A virtual image display device has been disclosed in JP 2020-024246 A that includes an image element configured to display an image, a first optical unit disposed on an optical path of image light, a second optical unit disposed on the image element side with respect to the first optical unit, a half mirror provided at a serrated surface formed at a bonding portion between the first optical unit and the second optical unit, and a transmission/reflection selection member provided on a light emitting side of the first optical unit. The transmission/reflection selection member, according to a polarized state of incident light, selectively transmits or reflects the light.

JP 2018-500584 A discloses a thermoformed multilayer reflective polarizer used for guiding image light from a display element. The thermoformed multilayer reflective polarizer is formed to be substantially rotationally symmetric with respect to an optical axis of the image light passing through an apex and is formed to be convex with respect to a plane perpendicular to the optical axis. For thermoformed multilayer reflective polarizer, s1/r1 is 0.2, where r1 is a radius about the optical axis, and s1 is displacement in the plane perpendicular to the optical axis.

In the virtual image display device disclosed in JP 2020-024246 A, design and manufacture of the serrated surface in the optical element is rather complicated. In the thermoformed multilayer reflective polarizer disclosed in JP 2018-500584 A, optical characteristics such as imaging characteristics are not obtained at a wide visual field angle, a telecentric optical system is hardly formed on the display element side, and it is difficult to shorten a distance from the display element to the optical element disposed closest to an observer. Therefore, there is a demand for a virtual image display device that is easily miniaturized and manufactured, and exhibits excellent optical characteristics at a wide visual field angle.

### SUMMARY

A virtual image display device of the present embodiment includes a display element configured to emit image light to a first side along a first direction, a first lens disposed farther on the first side than the display element and formed of a curved surface protruding toward the display element, a second lens that is disposed farther on the first side than the first lens, formed of a curved surface protruding toward the display element, and in which a curvature radius of a curved surface on the first side is larger than a curvature radius of a curved surface on a second side opposite to the first side in the first direction, a first polarizing layer disposed farther on the first side than the second lens, formed along the curved surface on the first side of the second lens, and configured to transmit a first polarized ray of incident light, and reflect a second polarized ray different from the first polarized ray of the incident light, a second polarizing layer disposed between the display element and the second lens in the first direction, and configured to transmit a first polarized ray of incident light, a first wavelength layer disposed between the second polarizing layer and the second lens in the first direction, formed along the curved surface on the first side of the first lens, and configured to impart, to incident light, a phase difference equivalent to ¼ of a wavelength of the light and transmit the incident light, a reflection layer disposed between the first wavelength layer and the second lens in the first direction, and configured to transmit a part of incident light, and reflect a remaining part of the incident light, and a second wavelength layer disposed between the reflection layer and the first polarizing layer in the first direction, formed along the curved surface on the first side of the first lens, and configured to impart, to incident light, a phase difference equivalent to ¼ of a wavelength of the light and transmit the incident light.

### BRIEF DESCRIPTION OF THE DRAWINGS

FIG. 1 is a schematic diagram illustrating a configuration of a virtual image display device of a first embodiment.

FIG. 2 is a partial exploded diagram illustrating a configuration of the virtual image display device of the first embodiment.

FIG. 3 is an exploded side view for explaining a course of image light in the virtual image display device in FIG. 1.

FIG. 4 is a schematic diagram illustrating a configuration of a virtual image display device of a second embodiment.

FIG. 5 is a schematic diagram illustrating a configuration of a virtual image display device of a third embodiment.

### DESCRIPTION OF EMBODIMENTS

Embodiments of the present disclosure will be described below with reference to the drawings. In each of the drawings, the scale of the dimensions may be changed depending on the constituent elements in order to make each of the constituent elements easier to see.

### First Embodiment

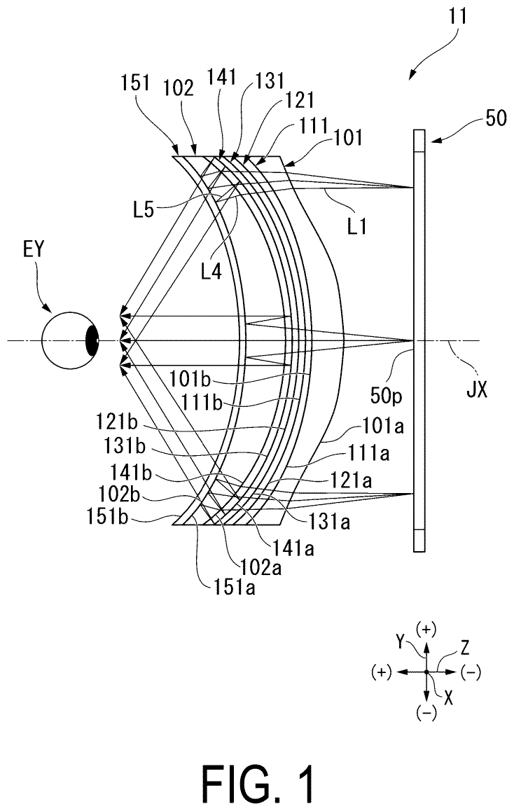

First, a first embodiment of the present disclosure will be described with reference to FIG. 1 to FIG. 3. FIG. 1 is a schematic diagram of a virtual image display device 11 of the first embodiment. As illustrated in FIG. 1, the virtual image display device 11 includes a display element 50, a lens 101, a polarizing layer 111, a ¼ wavelength layer 121, a reflection layer 131, a lens 102, a ¼ wavelength layer 141, and a polarizing layer 151.

In the virtual image display device 11, the display element 50, the lens 101, the polarizing layer 111, the ¼ wavelength layer 121, the reflection layer 131, the ¼ wavelength layer 141, the lens 102, the polarizing layer 151, and an eye EY of an observer are sequentially disposed from a −Z side to a +Z side along a Z direction.

The display element 50 displays an image or a video of an object to be visually recognized by the observer and emits image light. The display element 50 is not limited to a specific type of element, but is, for example, a video element including a self-luminous organic light emitting diode (OLED) such as an organic electro-luminescence, or a self-luminous display element such as an inorganic EL, an LED array, a laser array, or a quantum dot light-emitting element.

The display element 50 includes a display surface 50p that emits an image ray L1. A plurality of pixels (not illustrated) are provided along an X direction and a Y direction on the display surface 50p of the display element 50. That is, the plurality of pixels are two-dimensionally arrayed on the display surface 50p.

In the following description and drawings, two directions included in a plane parallel to the display surface 50p of the display element 50 and orthogonal to each other are referred to as the X direction and the Y direction. A direction orthogonal to the X direction and the Y direction and parallel to an optical axis of the image ray L1 displayed from the display surface 50p of the display element 50 is referred to as the Z direction. One side in the X direction is referred to as a −X side, and another side in the X direction is referred to as a +X side. One side in the Y direction is referred to as a −Y side, and another side in the Y direction is referred to as a +Y side. One side in the Z direction is referred to as a −Z side, and another side in the Z direction is referred to as a +Z side. Respective centers of the display element 50, the lens 101, the polarizing layer 111, the ¼ wavelength layer 121, the reflection layer 131, the ¼ wavelength layer 141, the lens 102, the polarizing layer 151, and the eye EY of the observer in the X direction and the Y direction overlap with each other.

The image rays L1 are emitted from respective pixels of the display surface 50p of the display element 50 to the +Z side, so as to spread in an XY plane including the X direction and the Y direction while moving to the +Z side with reference to axes parallel to the Z direction passing through substantially central positions of the respective pixels. The eye EY of the observer is located farther on the +Z side than the display element 50.

The lens 101 corresponds to a first lens. The lens 101 is disposed farther on the +Z side than the display element 50 and farther on the −Z side than the eye EY of the observer, and is disposed on an optical path of the image ray L1 emitted from the display element 50 along the Z direction.

The lens 101 includes a first surface 101a on the −Z side and a second surface 101b on the +Z side. The first surface 101a is a curved surface protruding toward the display element 50 side in the Z direction and is, for example, an aspherical surface protruding toward the −Z side. The first surface 101a of the lens 101 is applied with anti-reflection coating (not illustrated) or provided with an anti-reflection film (not illustrated). The second surface 101b is a curved surface protruding toward the display element 50 side in the Z direction and is, for example, an aspherical surface protruding toward the −Z side. The lens 101 collects rays incident from the −Z side toward a center side of the XY plane and toward the eye EY on the +Z side.

A shape, a curvature radius, and an aspherical coefficient of the first surface 101a and a shape, a curvature radius, and an aspherical coefficient of the second surface 101b are appropriately set according to sizes in the X direction and the Y direction of the display surface 50p of the display element 50, a distance between the display element 50 and the eye EY of the observer in the Z direction, and a refractive index of each constituent element of the virtual image display device 11, based on a result of a simulation or the like by ray tracing in consideration of a course of a ray in the virtual image display device 11 described later.

The lens 101 is formed of a material having translucency for image light in a visible wavelength band, and is formed of, for example, resin such as plastic. As a resin material of the lens 101, for example, OKP-1 (manufactured by Osaka Gas Chemical Co., Ltd.) which is a low birefringence material and an optical polyester resin is exemplified.

The polarizing layer 111 is in contact with the second surface 101b of the lens 101 from the +Z side and is provided at the second surface 101b. The polarizing layer 111 includes a first surface 111a on the −Z side and a second surface 111b on the +Z side. The polarizing layer 111 transmits only predetermined linearly polarized light of incident light. The predetermined polarized light is, for example, linearly polarized light having a vibration direction parallel to the Y direction.

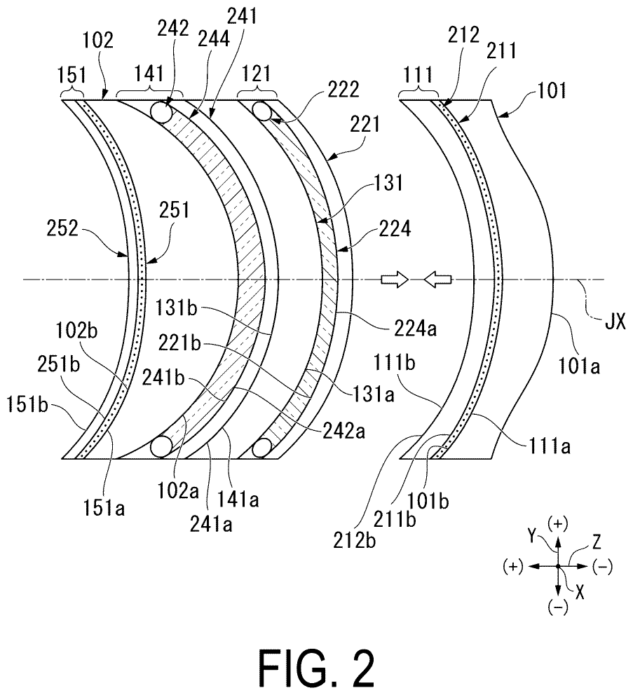

The polarizing layer 111 is not limited to a specific type of element as long as it is a polarizing layer that transmits only predetermined linearly polarized light as described above, but may include a wire grid polarizer 211. FIG. 2 is a side view of some constituent elements of the virtual image display device 11, and is a diagram in which each constituent element is enlarged in the Z direction when viewed from a direction orthogonal to the Z direction.

As illustrated in FIG. 2, the polarizing layer 111 includes the wire grid polarizer 211 and a base film 212. The wire grid polarizer 211 is in contact with the second surface 101b on the +Z side of the lens 101, is provided above the second surface 101b, and has a substantially constant thickness along the second surface 101b. A thickness of the wire grid polarizer 211, that is, thicknesses of a plurality of wires of the wire grid polarizer 211, are equal to or less than 1 μm, and more particularly, about several 100 nm.

The base film 212 is in contact with a second surface 211b, which is a curved surface on the +Z side of the wire grid polarizer 211, and covers the second surface 211b from the +Z side. A second surface 212b on the +Z side of the base film 212 is located farther on the +Z side than the second surface 101b at an interval corresponding to a substantially constant thickness along the second surface 101b of the lens 101. The base film 212 has translucency for light in the visible wavelength band and is made of, for example, a flexible resin. A thickness in the Z direction of the base film 212 may be about 50 um to 200 μm.

When the polarizing layer 111 is formed of the wire grid polarizer 211, the polarizing layer 111 exhibiting desired polarization characteristics is easily formed at the second surface 101b which is a curved surface of the lens 101, a variation in polarization characteristics exhibited in the XY plane by the polarizing layer 111 is minimized, and uniformity of the polarization characteristics exhibited in the XY plane by the polarizing layer 111 is increased.

On the other hand, for example, in a case where the polarizing layer 111 is formed of a film-like polarizing element, when the polarizing layer 111 is bonded to the second surface 101b of the lens 101, a degree of stretching or a stress of the film-like polarizing element varies depending on a position on the XY plane or a curvature radius of the second surface 101b, and thus there is a possibility that a variation in polarization characteristics exhibited on the XY plane by the polarizing layer 111 becomes apparent.

When the polarizing layer 111 is formed of the wire grid polarizer 211 as described above, the polarizing layer 111 transmits linearly polarized light having a vibration direction parallel to a direction orthogonal to an extending direction of the plurality of wires included in the wire grid polarizer 211. That is, when the polarizing layer 111 is formed of the wire grid polarizer 211 and transmits only linearly polarized light, of incident light, having a vibration direction parallel to the Y direction, the plurality of wires included in the polarizing layer 111 extend parallel to the X direction.

The ¼ wavelength layer 121 is in contact with the second surface 111b of the polarizing layer 111 from the +Z side and is provided at the second surface 111b. The ¼ wavelength layer 121 includes a first surface 121a on the −Z side and a second surface 121b on the +Z side. The ¼ wavelength layer 121 imparts a phase difference corresponding to a ¼ wavelength to incident light, converts incident linearly polarized light to be circularly polarized, and converts incident circularly polarized light to be linearly polarized, for example.

The ¼ wavelength layer 121 is not limited to a specific type of element as long as it is a wavelength layer or a phase difference layer that transmits only predetermined linearly polarized light as described above, but may be made of a birefringent material such as liquid crystal. The ¼ wavelength layer 121 includes, for example, an alignment film 221, a sealing material 222, and liquid crystal 224 which is a birefringent material.

The sealing material 222 is disposed on the −Z side of the reflection layer 131, is provided at a first surface 131a of the reflection layer 131, and is interposed between the alignment film 221 and the reflection layer 131 in the Z direction so as to provide a certain interval on the −Z side from the first surface 131a of the reflection layer 131. The sealing material 222 is, for example, an annular member that is provided at an outer peripheral edge of the reflection layer 131 about an axis JX parallel to the Z direction and is made of a resin having translucency for image light incident on the ¼ wavelength layer 121, or the like. Note that the sealing material 222 is, for example, a plurality of bead-shaped fine particles made of resin, and may be scattered at the first surface 221a of the alignment film 221.

The liquid crystal 224 is filled in a region surrounded by the alignment film 221, the sealing material 222, and the reflection layer 131, and is aligned along a light distribution direction of the alignment film 221. A layer filled with the liquid crystal 224 has a uniform thickness equivalent to a thickness of the sealing material 222 in the Z direction along the second surface 101b of the lens 101, a first surface 102a of the lens 102, and a second surface 221b on the +Z side of the alignment film 221.

The alignment film 221 is provided along the second surface 101b of the lens 101 and the first surface 102a of the lens 102, to be more specific, at a surface on the −Z side of the sealing material 222 so as to cover the liquid crystal 224 from the −Z side. The alignment film 221 has translucency for image light incident on the ¼ wavelength layer 121. The alignment film 221 has a light distribution direction corresponding to a phase difference to be imparted to light incident on the ¼ wavelength layer 121. For example, a groove structure or the like along the light distribution direction may be formed at the alignment film 221.

When the ¼ wavelength layer 121 is formed of a birefringent material, the ¼ wavelength layer 121 exhibiting desired phase difference imparting characteristics are easily formed at the second surface 111b of the polarizing layer 111 along the second surface 101b of the lens 101, a variation in phase difference imparting characteristics exhibited on the XY plane by the ¼ wavelength layer 121 is minimized, and uniformity of the phase difference imparting characteristics exhibited in the XY plane by the ¼ wavelength layer 121 is enhanced.

On the other hand, for example, in a case where the ¼ wavelength layer 121 is formed of a film-like wavelength element or a phase difference element, when the ¼ wavelength layer 121 is bonded to the second surface 111b of the polarizing layer 111, a degree of stretching of the film-like polarizing element varies depending on a position on the XY plane or a curvature radius of the second surface 111b, and thus there is a possibility that a variation in the polarization characteristics exhibited on the XY plane by the polarizing layer 111 becomes apparent.

The reflection layer 131 is in contact with the second surface 121b of the ¼ wavelength layer 121 from the +Z side. To be specific, the reflection layer 131 is formed by vapor deposition or the like at a first surface 241a on the −Z side of a ¼ wavelength layer 241 of the alignment film 141. The reflection layer 131 includes the first surface 131a on the −Z side and a second surface 131b on the +Z side. The reflection layer 131 is a so-called half mirror that transmits about a half of incident light and reflects about a half remaining. The reflection layer 131 is not limited to a specific type of element as long as it is a reflection layer that transmits about a half of incident light and reflects about another half as described above, and is, for example, a metal deposition film, a metal thin film, or a dielectric multilayer film. A thickness of the reflection layer 131 is, for example, equal to or less than 15 μm.

The ¼ wavelength layer 141 is in contact with the second surface 131b of the reflection layer 131 from the +Z side and is provided at the second surface 131b. The ¼ wavelength layer 141 includes a first surface 141a on the −Z side and a second surface 141b on the +Z side. The ¼ wavelength layer 141 imparts a phase difference corresponding to a ¼ wavelength to incident light, converts incident linearly polarized light to be circularly polarized, and converts incident circularly polarized light to be linearly polarized, for example.

The ¼ wavelength layer 141 is not limited to a specific type of element as long as it is a wavelength layer or a phase difference layer that transmits only predetermined linearly polarized light as described above, but may be made of a birefringent material such as liquid crystal. The ¼ wavelength layer 141 includes, for example, the alignment film 241, a sealing material 242, and liquid crystal 244 which is a birefringent material.

The sealing material 242 is disposed on the −Z side of the lens 102 and is provided at the first surface 102a of the lens 102. The sealing material 242 is, for example, an annular member that is provided at an outer peripheral edge of the lens 102 about the axis JX and is made of a resin having translucency for image light incident on the ¼ wavelength layer 141, or the like. Note that the sealing material 242 is, for example, a plurality of bead-shaped fine particles made of resin, and may be scattered at the first surface 241a of the alignment film 241. The sealing material 242 is disposed on the +Z side of the alignment film 241, and is interposed between the alignment film 241 and the lens 102 in the Z direction so as to provide a certain interval on the −Z side from the first surface 102a of the lens 102.

The liquid crystal 244 is filled in a region surrounded by the alignment film 241, the sealing material 242, and the lens 102, and is aligned along a light distribution direction of the alignment film 241. A layer filled with the liquid crystal 244 has a uniform thickness equivalent to a thickness of the sealing material 242 in the Z direction along the first surface 102a of the lens 102 and a second surface 241b of alignment film 241.

The alignment film 241 is provided at a surface on the −Z side of the sealing material 242 along the first surface 102a of the lens 102, and is in contact with a front surface on the −Z side of the liquid crystal 244. The alignment film 241 has translucency for image light incident on the ¼ wavelength layer 141. The alignment film 241 has a light distribution direction corresponding to a phase difference to be imparted to the light incident on the ¼ wavelength layer 141. A groove structure or the like along the light distribution direction may be formed at the alignment film 241.

When the ¼ wavelength layer 141 is formed of a birefringent material, the ¼ wavelength layer 141 exhibiting desired phase difference imparting characteristics is easily formed at the second surface 131b of the reflection layer 131 or a second surface 102b of the lens 102, a variation in the phase difference imparting characteristics exhibited on the XY plane by the ¼ wavelength layer 141 is minimized, and uniformity of the phase difference imparting characteristics exhibited on the XY plane by the ¼ wavelength layer 141 is enhanced.

When the ¼ wavelength layer 141 is formed of a birefringent material, as an example, the birefringent material is applied to the second surface 131b of the reflection layer 131 using a spray nozzle (not illustrated) in the same manner as the ¼ wavelength layer 121. Specifically, the birefringent material is mixed with a solvent to prepare an application liquid. After the application liquid is applied to the second surface 131b of the reflection layer 131, the solvent is removed. At this time, at the second surface 131b of the reflection layer 131, the birefringent material is uniformly laminated with a substantially constant thickness. Thereafter, the birefringent material is irradiated with electromagnetic waves such as ultraviolet rays to arrange alignment of the birefringent material in a predetermined direction, and alignment control is performed. The predetermined direction is, for example, a direction that forms 45 degrees with respect to each of the X direction and the Y direction and is orthogonal to the Z direction.

When the alignment control, the control and fixing of the alignment of the birefringent material are performed, as a method other than the method of ultraviolet irradiation as described above, for example, the solvent may be slowly removed in accordance with a speed of alignment of liquid crystal molecules, or a cholesteric liquid crystal composition may be used as the birefringent material and the composition may be photo-cured while in a liquid crystal phase state.

A ¼ wavelength layer including the ¼ wavelength layer 141 may be formed and fabricated as described next. For example, a photo-cross-linkable polymer liquid crystal material is applied at a base material made of a transparent resin which has flexibility and is provided in a state in which variations in transmission characteristics and polarization characteristics due to stretching or bending are suppressed, thereby forming a photo-cross-linkable polymer liquid crystal material layer, that is, a thin film formed of the photo-cross-linkable polymer liquid crystal material. By irradiating the thin film of the photo-cross-linkable polymer liquid crystal material with a linearly polarized ultraviolet ray having a controlled polarization direction, the thin film of the photo-cross-linkable polymer liquid crystal material can be cured to control an alignment state of molecular species exhibiting liquid crystallinity. At this time, among the molecular species exhibiting liquid crystallinity by the ultraviolet ray, the molecular species extending in a direction coinciding with a polarization direction of the ultraviolet ray are cross-linked, and the alignment state is fixed in the same direction as the polarization direction. Thereafter, by annealing the thin film, the molecular species exhibiting liquid crystallinity whose alignment state is not changed by the ultraviolet irradiation can be liquid-crystallized, and the alignment state of these molecular species can be made to coincide with a polymer portion which is already in a target alignment state. As a result, the alignment state is fixed. That is, the wavelength layer is obtained that is formed of the thin film in which the alignment directions of most of the molecular species exhibiting liquid crystallinity constituting the photo-cross-linkable polymer liquid crystal material are made to coincide with each other. In such a wavelength layer, retardation can be adjusted by adjusting a thickness thereof.

The lens 102 corresponds to a second lens. The lens 102 is disposed farther on the +Z side than the lens 101 and farther on the −Z side than the eye EY of the observer, and is disposed on an optical path of the image ray L1 emitted from the reflection layer 131 to the +Z side.

The lens 102 includes the first surface 102a on the −Z side and the second surface 102b on the +Z side. The first surface 102a and the second surface 101b are curved surfaces protruding toward the display element 50 side in the Z direction and are, for example, aspherical surfaces protruding toward the −Z side. The lens 102 is, for example, a positive meniscus lens including a convex curved surface on the −Z side. The lens 102 collects rays incident from the −Z side toward a center side of the XY plane and toward the eye EY on the +Z side.

A refractive index of the lens 102 is about 0.1 to 0.2 lower than a refractive index of the lens 101. Thus, a telecentric optical system including the lenses 101 and 102 is easily formed. The lens 102 is formed of a material having translucency for image light in the visible wavelength band, and is formed of, for example, resin such as plastic. As the resin material of the lens 102, for example, APEL (registered trademark, manufactured by Mitsui Chemicals, Inc.) which is a low birefringence material and has a high refractive index is exemplified. The second surface 102b of the lens 102 is applied with anti-reflection coating (not illustrated) or provided with an anti-reflection film (not illustrated).

A curvature radius of the first surface 102a of the lens 102 is equivalent to the curvature radius of the second surface 101b of the lens 101. The curvature radius of the second surface 102b is larger than the curvature radius of the first surface 102a. A shape and a curvature radius of the first surface 102a and a shape and a curvature radius of the second surface 102b are appropriately set according to sizes in the X direction and the Y direction of the display surface 50p of the display element 50, a distance between the display element 50 and the eye EY of the observer in the Z direction, and a refractive index of each constituent element of the virtual image display device 11, based on a result of a simulation or the like by ray tracing in consideration of a course of a ray in the virtual image display device 11 described later.

Note that the ¼ wavelength layer 141 may be in contact with the reflection layer 131 from the +Z side.

The polarizing layer 151 is in contact with the second surface 102b of the lens 102 from the +Z side and is provided at the second surface 102b. The polarizing layer 151 includes a first surface 151a on the −Z side and a second surface 151b on the +Z side. The polarizing layer 151 transmits only predetermined linearly polarized light of incident light and reflects remaining light other than the predetermined linearly polarized light. The predetermined polarized light is, for example, linearly polarized light having a vibration direction parallel to the Y direction.

The polarizing layer 151 is not limited to a specific type of element as long as it is a polarizing layer that transmits only predetermined linearly polarized light as described above, and reflects remaining light other than the predetermined linearly polarized light, but may be formed of a wire grid polarizer. When the polarizing layer 151 is formed of a wire grid polarizer, the polarizing layer 151 exhibiting desired polarization characteristics is easily formed at the second surface 102b which is the curved surface of the lens 102, a variation in the polarization characteristics exhibited on the XY plane by the polarizing layer 151 is minimized, and uniformity of the polarization characteristics exhibited on the XY plane by the polarizing layer 151 is increased.

The polarizing layer 151 includes a wire grid polarizer 251 and a base film 252. The wire grid polarizer 251 is in contact with the second surface 102b on the +Z side of the lens 102, is provided above the second surface 102b, and has a substantially constant thickness along the second surface 102b. A thickness of the wire grid polarizer 251, that is, thicknesses of a plurality of wires of the wire grid polarizer 251, are equal to or less than 1 μm, and more particularly, about several 100 nm.

The base film 252 is in contact with a second surface 251b, which is a curved surface on the +Z side of the wire grid polarizer 251, and covers the second surface 251b from the +Z side. The second surface 252b on the +Z side of the base film 252 is located farther on the +Z side than the second surface 102b at an interval corresponding to a substantially constant thickness along the second surface 102b of the lens 102. The base film 252 has translucency for light in the visible wavelength band and is made of, for example, a flexible resin. A thickness of the base film 252 in the Z direction may be about 50 μm to 200 μm.

When the polarizing layer 151 is formed of the wire grid polarizer 251 as described above, the polarizing layer 151 transmits linearly polarized light having a vibration direction parallel to a direction orthogonal to an extending direction of the plurality of wires included in the wire grid polarizer 251. That is, when the polarizing layer 151 is formed of the wire grid polarizer 251 and transmits only linearly polarized light having a vibration direction parallel to the Y direction of incident light, the plurality of wires included in the polarizing layer 151 extend parallel to the X direction.

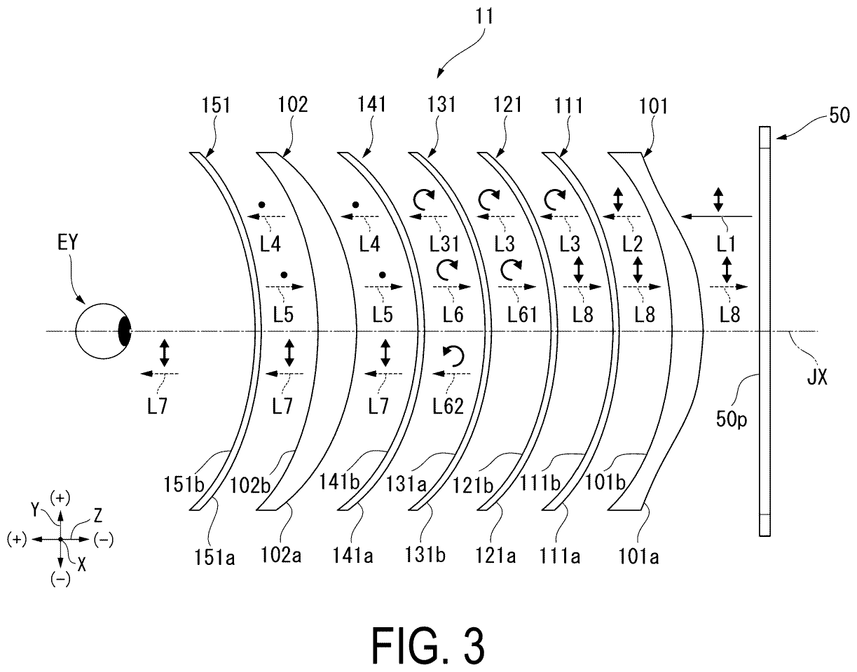

FIG. 3 is a diagram for explaining a course of image light in the virtual image display device 11 of the first embodiment. In FIG. 3, in order to clearly illustrate polarization of the image light, constituent elements are disassembled so as to be spaced apart from each other in the Z direction.

As illustrated in FIG. 3, the image ray L1 emitted from the display surface 50p of the display element 50 travels to the +Z side, is refracted by the first surface 101a of the lens 101, and approaches the axis JX passing through a center in the X direction and the Y direction of the display element 50 in the XY plane. The image ray L1 incident on the lens 101 from the first surface 101a is refracted again by the second surface 101b, is emitted from the lens 101, and is incident on the polarizing layer 111. Of the image ray L1 incident on the polarizing layer 111, an image ray L2 which is linearly polarized and whose polarization direction is parallel to the Y direction is transmitted through the polarizing layer 111 and is emitted to the +Z side. Of the image ray L1 incident on the polarizing layer 111, linearly polarized light whose polarization direction is not parallel to the Y direction, that is, light other than the image ray L2 is reflected by the polarizing layer 111 and is emitted to the −Z side or absorbed by the polarizing layer 111.

The image ray L2 emitted from the polarizing layer 111 to the +Z side is incident on the ¼ wavelength layer 121 and is converted into an image ray L3 being circularly polarized by the ¼ wavelength layer 121. The image ray L3 is right-handed or left-handed circularly polarized, for example, right-handed circularly polarized. The image ray L3 is emitted from the ¼ wavelength layer 121 to the +Z side and is incident on the reflection layer 131. An image ray L31 having a light amount approximately half that of the image light L3 incident on the reflection layer 131 is transmitted through the reflection layer 131 and is emitted to the +Z side. An image ray L32 having a light amount that is a remaining approximately half of the amount of the image light L3 and incident on the reflection layer 131 is reflected by the reflection layer 131 and is emitted to the −Z side.

The image ray L31 emitted from the reflection layer 131 to the +Z side is incident on the ¼ wavelength layer 141 and is converted into an image ray L4 being linearly polarized by the ¼ wavelength layer 141. A polarization direction of the image ray L4 is parallel to the X direction and orthogonal to the Y direction. The image ray L4 is emitted from the ¼ wavelength layer 141 to the +Z side and is incident on the lens 102.

The image ray L4 incident on the lens 102 is refracted by the first surface 102a of the lens 102, further approaches the axis JX in the XY plane, and reaches the second surface 102b of the lens 102. The image ray L4 that reaches the second surface 102b of the lens 102 reaches the first surface 151a in contact with the second surface 102b, however, since the polarization direction is orthogonal to the Y direction, the image ray L4 is reflected by the first surface 151a, is emitted to the −Z side, and is emitted in a direction away from the axis JX in the XY plane as an image ray L5.

The image ray L5 emitted from the lens 102 to the −Z side is incident on the ¼ wavelength layer 141, is converted into an image ray L6 being right-handed circularly polarized by the ¼ wavelength layer 141, and is emitted from the ¼ wavelength layer 141 to the −Z side. The image ray L6 emitted from the ¼ wavelength layer 141 to the −Z side is incident on the reflection layer 131. An image ray L61 having a light amount approximately half that of the image ray L6 incident on the reflection layer 131 is transmitted through the reflection layer 131 and is emitted to the −Z side. The image ray L61 is right-handed circularly polarized, similarly to the image ray L6 incident on the reflection layer 131 from the +Z side. An image ray L62 having a light amount that is a remaining approximately half of the amount of the image ray L6 incident on the reflection layer 131 is reflected by the reflection layer 131 and is emitted to the +Z side. By being reflected by the reflection layer 131, the image ray L62 is converted to be left-handed circularly polarized that is opposite to the image ray L6 incident on the reflection layer 131 from the +Z side.

The image ray L62 emitted from the reflection layer 131 to the +Z side is incident on the ¼ wavelength layer 141, is converted into an image ray L7 being linearly polarized by the ¼ wavelength layer 141, and is emitted from the ¼ wavelength layer 141 to the +Z side. A polarization direction of the image ray L7 is parallel to the Y direction. The image ray L7 emitted from the ¼ wavelength layer 141 to the +Z side is transmitted through the lens 102 and approaches the axis JX on the XY plane by the lens 102 while being emitted to the +Z side. The image ray L7 emitted from the lens 102 to the +Z side is transmitted through the polarizing layer 151, is emitted to the +Z side, and reaches a predetermined imaging position farther on the +Z side than the polarizing layer 151 and farther on the +Z side than the eye EY of the observer.

The image ray L61 emitted from the reflection layer 131 to the −Z side is incident on the ¼ wavelength layer 121 and is converted into an image ray L8 being linearly polarized by the ¼ wavelength layer 121. A polarization direction of the image ray L8 is parallel to the Y direction. The image ray L8 is transmitted through the polarizing layer 111 along the Z direction and returns to the display element 50 from the −Z side.

When the image rays L1 emitted from the plurality of pixels at the display surface 50p of the display element 50 propagate as described above, the image rays L7 are imaged at a predetermined imaging position, and a virtual image is formed. The observer observes the virtual image from the +Z side. In the virtual image display device 11, the image ray L5 emitted from at least an outer peripheral portion of the XY plane of the polarizing layer 151 to the −Z side is reflected farther on an outer peripheral side than the image ray L4 incident on the outer peripheral portion of the polarizing layer 151 from the −Z side. Therefore, the observer can observe a virtual image at a wide visual field angle. In the virtual image display device 11, excellent imaging characteristics at a wide visual field angle are obtained.

The virtual image display device 11 of the first embodiment described above includes the display element 50, the lens (first lens) 101, the lens (second lens) 102, the polarizing layer (a first polarizing layer) 151, the polarizing layer (a second polarizing layer) 111, the ¼ wavelength layer (a first wavelength layer) 121, the reflection layer 131, and the ¼ wavelength layer (a second wavelength layer) 141. The display element 50 emits the image ray L1 to the +Z side (a first side) along the Z direction (a first direction). The lens 101 is disposed farther on the +Z side than the display element 50 and includes the first surface (curved surface) 101a and the second surface (curved surface) 101b that protrude toward the display element 50. The lens 102 is disposed farther on the +Z side than the lens 101, and includes the first surface (curved surface) 102a and the second surface (curved surface) 102b protruding toward the display element 50. The curvature radius of the second surface (curved surface on the first side) 102b on the +Z side of the lens 102 is larger than the curvature radius of the first surface (curved surface on the second side) 102a on the −Z side opposite to the +Z side in the Z direction. The polarizing layer 151 is disposed more farther on the +Z side than the lens 102 and is disposed closer to the eye EY of the observer than the other constituent elements in the virtual image display device 11. The polarizing layer 151 is formed along the second surface 102b on the +Z side of the lens 102. The polarizing layer 151 transmits linearly polarized light (a first polarized ray) having a polarization direction parallel to the Y direction of incident light including the image ray (light) L4, and reflects polarized light (a second polarized ray) other than the linearly polarized light having the polarization direction parallel to the Y direction of the incident light to the −Z side (second side opposite to the first side) in the Z direction. The polarizing layer 111 is disposed between the display element 50 and the lens 102 in the Z direction, is formed along the second surface 101b of the lens 101 and the first surface 101a of the lens 102, and transmits linearly polarized light having a polarization direction parallel to the Y direction of incident light. The ¼ wavelength layer 121 is disposed between the polarizing layer 111 and the lens 102 in the Z direction, is formed along the second surface (curved surface on the first side) 101b of the lens 101 and the first surface 101a of the lens 102, and imparts, to incident light, a phase difference corresponding to ¼ of a wavelength of the light and transmits the incident light. The reflection layer 131 is disposed between the ¼ wavelength layer 121 and the lens 102 in the Z direction, is formed along the second surface (curved surface on the first side) 101b of the lens 101 and the first surface 101a of the lens 102, transmits a part of incident light, and reflects a remaining part of the incident light. The ¼ wavelength layer 141 is disposed between the reflection layer 131 and the lens 102 in the Z direction, is formed along the second surface 101b of the lens 101 and the first surface 101a of the lens 102, and imparts, to incident light, a phase difference corresponding to ¼ of a wavelength of the light and transmits the incident light.

In the virtual image display device 11 of the first embodiment, the lenses 101 and 102 are each formed of the curved surface protruding toward the display element 50 in the same manner in the Z direction, and the polarizing layer 111, the ¼ wavelength layer 121, the reflection layer 131, the ¼ wavelength layer 141, and the polarizing layer 151 are formed along the second surface 101b of the lens 101 and the second surface 102b of the lens 102, and can be designed based on a ray tracing method of geometric optics. Therefore, the virtual image display device 11 of the first embodiment is easy to be miniaturized and manufactured. Further, in the virtual image display device 11 of the first embodiment, the curvature radius of the second surface 102b of the lens 102 is larger than the curvature radius of the first surface 102a, and a curvature of the second surface 102b is smaller than a curvature of the first surface 102a. Note that a curvature means an inverse number of a curvature radius. Therefore, after the image light is folded and propagated in the Z direction and the image light including the image ray L5 is folded outward in a radial direction with respect to the axis JX by the polarizing layer 151, a virtual image is formed at a predetermined imaging position. Therefore, the virtual image display device 11 of to the first embodiment exhibits excellent optical characteristics at a wide visual field angle.

In the virtual image display device 11 of the first embodiment, the ¼ wavelength layers 121 and 141 disposed between the lenses 101 and 102 in the Z direction in which the image light including the image rays L1 to L7 propagates are formed along the second surface 101b of the lens 101 and the first surface 102a of the lens 102. To be more specific, in the virtual image display device 11 of the first embodiment, as the ¼ wavelength layers 121 and 141, a plate-shaped wave plate or a phase difference film disposed at a plate surface or the like of a flat substrate as in the related art is not used, and materials of the ¼ wavelength layers 121 and 141 are formed along the second surface 101b and the first surface 102a, and a phase disturbance does not occur at the second surface 101b and the first surface 102a. Therefore, according to the virtual image display device 11 of the first embodiment, it is possible to exhibit excellent optical characteristics at a wide visual field angle, to obtain a light amount of image light imaged toward the eye EY of the observer, and to improve visibility of a virtual image. In the virtual image display device 11 of the first embodiment, for example, a visual field angle exceeding 100 degrees can be achieved by using the relatively small display element 50 of equal to or less than 1.5 inches.

In the virtual image display device 11 of the first embodiment, the refractive index of the lens 102 is lower than the refractive index of the lens 101.

According to the virtual image display device 11 of the first embodiment, since the image light incident on the lens 102 from the −Z side is efficiently totally reflected and is emitted outward in the radial direction with respect to the axis JX, it is possible to reduce the entire device in thickness and increase the visual field angle.

In the virtual image display device 11 of the first embodiment, the polarizing layer 111, the ¼ wavelength layer 121, the reflection layer 131, and the ¼ wavelength layer 141 are sequentially disposed between the lens 101 and the lens 102 from the −Z side toward the +Z side in the Z direction. The polarizing layer 111, the ¼ wavelength layer 121, the reflection layer 131, and the ¼ wavelength layer 141 are laminated between the lenses 101 and 102.

According to the virtual image display device 11 of the first embodiment, as described above, the thin folding optical system in which the size in the Z direction is suppressed is configured, both the excellent optical characteristics at a wide visual field angle and the telecentricity are achieved in a compatible manner, and a virtual image with high visibility is obtained.

In the virtual image display device 11 of the first embodiment, the ¼ wavelength layer 121 includes the alignment film (a first alignment film) 221, the sealing material 222, and the liquid crystal 224 which is a birefringent material. The alignment film 221 is provided along the first surface 102a on the −Z side of the lens 102. The sealing material 222 is disposed on the −Z side of the alignment film 221 and is interposed to provide a predetermined interval from the second surface 221b on the +Z side of the alignment film 221 to the −Z side. The liquid crystal 224 is filled in a region surrounded by the alignment film 221, the sealing material 222, and the reflection layer 131, and is aligned along a light distribution direction of the alignment film 221.

According to the virtual image display device 11 of the first embodiment, along the first surface 102a which is the curved surface of the lens 102, to be specific, along the first surface 131a of the reflection layer 131, it is possible to provide the ¼ wavelength layer 121 that uniformly imparts, to the image ray L3, a phase difference corresponding to ¼ of a wavelength, and does not cause a phase disturbance. As a result, in the virtual image display device 11 of the first embodiment, excellent optical characteristics at a wide visual field angle are obtained.

In the virtual image display device 11 of the first embodiment, the ¼ wavelength layer 141 is configured similarly to the ¼ wavelength layer 121, and includes the alignment film (a second alignment film) 241, the sealing material 242, and the liquid crystal 244 which is a birefringent material. The alignment film 241 is provided along the first surface 102a on the −Z side of the lens 102. The sealing material 242 is disposed on the −Z side of the alignment film 241 and is interposed to provide a predetermined interval from the second surface 241b on the +Z side of the alignment film 241 to the +Z side. The liquid crystal 244 is filled in a region surrounded by the alignment film 241, the sealing material 242, and the reflection layer 131, and is aligned along the light distribution direction of the alignment film 241.

According to the virtual image display device 11 of the first embodiment, along the second surface 101b of the lens 101, to be specific, along the first surface 102a of the lens 102, it is possible to provide the ¼ wavelength layer 141 which uniformly imparts a phase difference corresponding to ¼ of a wavelength to the image rays L31, L5, L62 and the like and does not cause a phase disturbance. As a result, in the virtual image display device 11 of the first embodiment, excellent optical characteristics at a wide visual field angle are obtained.

In the virtual image display device 11 of the first embodiment, the polarizing layer 111 includes the wire grid polarizer (a second wire grid polarizer) 211 provided at the second surface 101b of the lens 101 and the base film (a second base film) 212 covering the wire grid polarizer 211 from the +Z side.

According to the virtual image display device 11 of the first embodiment, it is possible to provide the polarizing layer 111 which emits only predetermined linearly polarized light of the image rays L31, L5, L62, and the like along the second surface 101b of the lens 101 and does not cause a variation in polarization characteristics. As a result, in the virtual image display device 11 of the first embodiment, excellent optical characteristics at a wide visual field angle are obtained.

In the virtual image display device 11 of the first embodiment, the polarizing layer 151 includes the wire grid polarizer (a first wire grid polarizer) 251 provided at the second surface 102b of the lens 102 and the base film (a first base film) 252 covering the wire grid polarizer 251 from the +Z side.

According to the virtual image display device 11 of the first embodiment, it is possible to provide, along the second surface 102b of the lens 102, the polarizing layer 151 that emits only predetermined linearly polarized light of the image rays L4, L7, and the like and does not cause a variation in polarization characteristics. As a result, in the virtual image display device 11 of the first embodiment, excellent optical characteristics at a wide visual field angle are obtained.

In the virtual image display device 11 of the first embodiment, the polarizing layer 151 is formed above the second surface 102b of the lens 102 and is in contact with the second surface 102b.

According to the virtual image display device 11 of the first embodiment, it is possible to achieve miniaturization in the Z direction, that is, a reduction in thickness. In addition, according to the virtual image display device 11 of the first embodiment, the polarized state of the image light including the image rays L4 and L7 which are emitted from the lens 102 and are incident on the polarizing layer 151 is not disturbed before being incident on the polarizing layer 151, the polarized state of the image light is caused to act as desired, and excellent optical characteristics can be obtained.

In the virtual image display device 11 of the first embodiment, the ¼ wavelength layer 141 is formed above the first surface 102a of the lens 102 having an equivalent curvature radius to that of the second surface 101b along the second surface 101b of the lens 101 and is in contact with the first surface 102a.

According to the virtual image display device 11 of the first embodiment, it is possible to achieve miniaturization in the Z direction, that is, a reduction in thickness. In addition, according to the virtual image display device 11 of the first embodiment, a phase of the image light including the image rays L31, L5, and L62 is not greatly varied before being incident on the ¼ wavelength layer 141, a desired phase difference is imparted to the phase of the image light, and excellent optical characteristics can be obtained.

Note that in the virtual image display device 11 of the first embodiment, the display element 50, the lens 101, the polarizing layer 111, the ¼ wavelength layer 121, the reflection layer 131, the ¼ wavelength layer 141, the lens 102, and the polarizing layer 151 are sequentially disposed from the −Z side to the +Z side, and the constituent elements adjacent to each other in the Z direction are in contact with each other. Accordingly, it is possible to achieve miniaturization in the Z direction of the virtual image display device 11 of the first embodiment, that is, a reduction in thickness of the entire device. In addition, as described above, since the constituent elements adjacent to each other in the Z direction of the virtual image display device 11 of the first embodiment, that is, the devices or the layers are in contact with each other, an optical action by each layer can be more accurately applied to the image light, and it is possible to obtain desired excellent optical characteristics and a clear virtual image.

### Second Embodiment

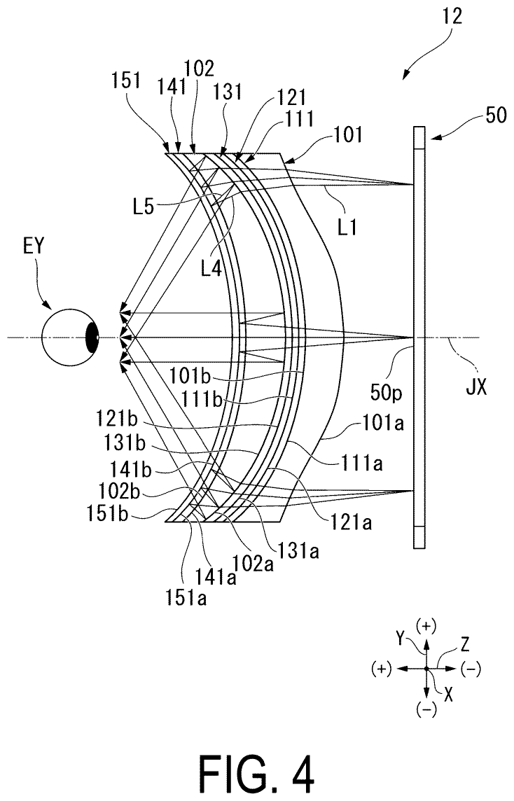

Next, a second embodiment of the present disclosure will be described with reference to FIG. 4. As for virtual image display devices of the following embodiments, only configurations different from those of the virtual image display device 11 of the first embodiment will be described. Among the constituent elements of the virtual image display device of each embodiment, constituent elements common to those of the virtual image display device 11 of the first embodiment are denoted by the same reference numerals as the corresponding constituent elements of the virtual image display device 11 of the first embodiment. Description of the constituent elements common to those of the virtual image display device 11 of the first embodiment will be omitted.

FIG. 4 is a schematic diagram of a virtual image display device 12 of the second embodiment. As illustrated in FIG. 4, similarly to the virtual image display device 11, the virtual image display device 12 includes the display element 50, the lens 101, the polarizing layer 111, the ¼ wavelength layer 121, the reflection layer 131, the lens 102, the ¼ wavelength layer 141, and the polarizing layer 151. In the virtual image display device 12, the ¼ wavelength layer 141 is disposed between the lens 102 and the polarizing layer 151 in the Z direction.

The ¼ wavelength layer 141 is made of a birefringent material. In the virtual image display device 12, as an example, the birefringent material is applied to the second surface 111b of the polarizing layer 111 using an injection nozzle (not illustrated). Specifically, the birefringent material is mixed with a solvent to prepare an application liquid. After the application liquid is applied to the second surface 111b of the polarizing layer 111, the solvent is removed. At this time, the birefringent material is uniformly laminated, with a substantially constant thickness, at the second surface 111b of the polarizing layer 111. Thereafter, the birefringent material is irradiated with electromagnetic waves such as ultraviolet rays to arrange alignment of the birefringent material in a predetermined direction, and alignment control is performed. The predetermined direction is, for example, a direction that forms 45 degrees with respect to each of the X direction and the Y direction and is orthogonal to the Z direction.

In the virtual image display device 12 of the second embodiment described above, it is possible to obtain similar operational effects as operational effects by configurations common to those of the virtual image display device 11 of the first embodiment.

In the virtual image display device 12 of the second embodiment, the polarizing layer 111, the ¼ wavelength layer 121, and the reflection layer 131 are sequentially disposed toward the first side between the lens 101 and the lens 102 in the Z direction. In the virtual image display device 12 of the second embodiment, the ¼ wavelength layer 141 is disposed between the lens 102 and the polarizing layer 151 in the Z direction.

According to the virtual image display device 12 of the second embodiment, as with the virtual image display device 11 of the first embodiment, a thin folding optical system in which a size in the Z direction is suppressed is configured, both excellent optical characteristics at a wide visual field angle and telecentricity are achieved in a compatible manner, and a virtual image with high visibility is obtained.

In addition, in the virtual image display device 12 of the second embodiment, the application liquid containing the birefringent material is applied, with a uniform thickness, to the second surface 102b of the lens 102, which is a concave surface when viewed from the +Z side, and is aligned in a predetermined light distribution direction. As a result, it is possible to provide, along the second surface 102b of the lens 102, the ¼ wavelength layer 141 that uniformly imparts a phase difference corresponding to ¼ of the wavelength to the image rays L31, L5, L62 and the like, and does not cause a phase disturbance. As a result, also in the virtual image display device 12 of the second embodiment, excellent optical characteristics at a wide visual field angle are obtained.

Here, an example of design of the virtual image display device 12 of the second embodiment will be described. Sizes of the display surface 50p of the display element 50 in the X direction and the Y direction are set to be from 1.0 inches to 1.5 inches, and to be specific, 1.1 inches. A distance in the Z direction from the display surface 50p of the display element 50 to an apex of the first surface 102a of the lens 102 is 17 mm, to be specific, 16 mm. A distance in the Z direction from the display surface 50p of the display element 50 to a predetermined imaging position of image light is set to be equal to or less than 23 mm, and to be specific, 22 mm. A maximum thickness in the Z direction of the lens 102, that is, a thickness of the lens 102 on the axis JX is set to be equal to or less than 12 mm, to be specific, 11 mm.

The resin material of the lens 101 is OKP-1, and the resin material of the lens 102 is APEL, to be specific, APEL5514. A refractive index of OKP-1 constituting the lens 101 is 1.669656 at a wavelength of 465 nm, 1.654206 at a wavelength of 520 nm, and 1.638017 at a wavelength of 620 nm. A refractive index of APEL5514 constituting the lens 102 is 1.552944 at a wavelength of 465 nm, 1.548179 at a wavelength of 520 nm, and 1.542599 at a wavelength of 620 nm.

By applying the above-described design and conditions to the configuration of the virtual image display device 12, a visual field angle (FOV) of equal to or greater than 100 degrees is obtained, and specifically, a visual field angle of 120 degrees is obtained. Further, by applying the above-described design and conditions to the configuration of the virtual image display device 12, a widest visual field angle at which the telecentricity is obtained is equal to or less than 10 degrees, and specifically, equal to or less than 7 degrees.

Table 1 illustrates an example of the first surface 101a and the second surface 101b of the lens 101, and the first surface 102a and the second surface 102b of the lens 102.

TABLE 1

| | CURVATURE | ASPHERICAL COEFFICIENT | | | | |
|---|---|---|---|---|---|---|
| | RADIUS [mm] | K | A₄ | A₆ | A₈ | A₁₀ |
| 101a | −17.6 | −1 | 5.26 × 10⁻⁵ | −2.07 × 10⁻⁷ | 1.90 × 10⁻¹⁰ | 0 |
| 101b | −27.2 | −1 | −1.22 × 10⁻⁵ | −2.30 × 10⁻⁸ | 2.18 × 10⁻¹¹ | −1.00 × 10⁻¹³ |
| 102a | −27.2 | −1 | −1.22 × 10⁻⁵ | −2.30 × 10⁻⁸ | 2.18 × 10⁻¹¹ | −1.00 × 10⁻¹³ |
| 102b | −50 | −1 | −2.50 × 10⁻⁵ | 0 | 0 | 0 |

Aspherical coefficients of the respective surfaces in Table 1 represent coefficients A₄, A₆, A₈, and A₁₀ in the following Equation (1). In Equation (1), R represents a curvature radius. In Equation (1), K represents a conic coefficient.

$$\begin{matrix}[ Math 1 ] & \\ \begin{matrix}Z = f ( Y ) \\ = \frac{{Y}^{2}}{R [ 1 + {\{ 1 - ( 1 + k ) {Y}^{2} / {R}^{2} \}}^{1 / 2} ]} + \\ {A}_{4} {Y}^{4} + {A}_{6} {Y}^{6} + {A}_{8} {Y}^{8} + {A}_{10} {Y}^{10}\end{matrix} & ( 1 )\end{matrix}$$

### Third Embodiment

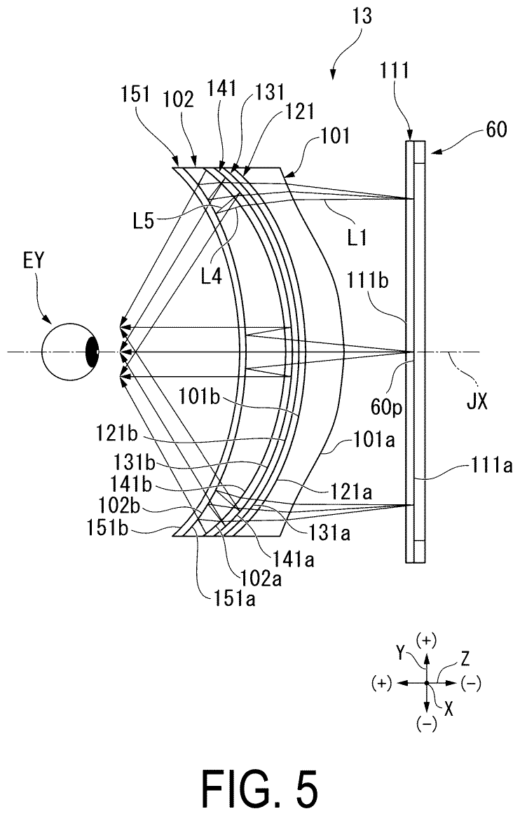

Next, a third embodiment of the present disclosure will be described with reference to FIG. 5. FIG. 5 is a schematic diagram of a virtual image display device 13 of the third embodiment. As illustrated in FIG. 5, the virtual image display device 13 includes a display element 60, the lens 101, the polarizing layer 111, the ¼ wavelength layer 121, the reflection layer 131, the ¼ wavelength layer 141, the lens 102, and the polarizing layer 151.

As in the case of the display element 50, the display element 60 displays an image or a video to be visually recognized by an observer and emits image light. The display element 60 is, for example, a liquid crystal display, is coupled to a terminal device or an image generation device (not illustrated) in a wired or wireless manner, and emits the image light in accordance with image information received from the terminal device or the image generation device. The terminal device or the image generation device is, for example, a smartphone, a tablet terminal device, or a computer.

The display element 60 includes a display surface 60p that emits the image ray L1. A plurality of pixels (not illustrated) are provided along the X direction and the Y direction at the display surface 60p of the display element 60. That is, the plurality of pixels are two-dimensionally arrayed at the display surface 60p.

In the virtual image display device 13, the polarizing layer 111 is disposed between the display element 60 and the lens 101 in the Z direction, specifically, is disposed immediately next to the display element 60 on the +Z side, and is in contact with the display element 60. That is, the first surface 111a of the polarizing layer 111 is in contact with the display surface 60p of the display element 60. The first surface 111a and the second surface 111b of the polarizing layer 111 are planar surfaces orthogonal to the axis JX and parallel to the display surface 60p of the display element 60.

The polarizing layer 111 of the virtual image display device 13 may be the wire grid polarizer 211, may be an absorption type polarizing plate, or may be a polarizing element that comes with a liquid crystal display or a liquid crystal panel. Note that in the Z direction, there may be an appropriate interval between the display element 60 and the polarizing layer 111.

In the virtual image display device 12 of the second embodiment described above, it is possible to obtain similar operational effects as operational effects by configurations common to those of the virtual image display device 11 of the first embodiment.

In the virtual image display device 13 of the third embodiment, the polarizing layer 111 is disposed between the display element 60 and the lens 101 in the Z direction. In the virtual image display device 13 of the third embodiment, the ¼ wavelength layer 121 and the reflection layer 131 are sequentially disposed toward the +Z side between the lens 101 and the lens 102 in the Z direction.

According to the virtual image display device 13 of the third embodiment, as with the virtual image display device 11 of the first embodiment, a thin folding optical system in which a size in the Z direction is suppressed is configured, both excellent optical characteristics at a wide visual field angle and telecentricity are achieved in a compatible manner, and a virtual image with high visibility is obtained.

In the virtual image display device 13 of the third embodiment, the ¼ wavelength layer 121 is formed above the second surface 101b of the lens 101 and is in contact with the second surface 101b.

According to the virtual image display device 13 of the third embodiment, it is possible to achieve miniaturization in the Z direction, that is, a reduction in thickness. In addition, according to the virtual image display device 13 of the third embodiment, a phase of the image light including the image ray L1 is not greatly varied before being incident on the ¼ wavelength layer 121, a desired phase difference is imparted to the phase of the image light, and excellent optical characteristics can be obtained.

### Other Embodiments

Note that in the virtual image display device of the present disclosure, the polarizing layer (first polarizing layer) 151 is formed along the second surface (a side surface on the first side) 102b of the lens 102. The state of being formed along the second surface 102b includes a state of being directly formed or applied above the second surface 102b of the lens 102 like the polarizing layer 151 of each of the above-described embodiments and having a curvature radius equivalent to that of the second surface 102b at a front surface, and further includes a state of being disposed close to the second surface 102b with a slight interval so as not to change emission characteristics of image light in the Z direction and having the curvature radius equivalent to that of the second surface 102b at the front surface, a state where a thin layer structure is interposed between the polarizing layer 151 and the second surface 102b so as not to affect polarization characteristics of the image light in the Z direction and the curvature radius at the front surface is equivalent to that of the second surface 102b, or the like.

Similarly, in the virtual image display device of the present disclosure, the ¼ wavelength layer (first wave layer) 121 is formed along the second surface (side surface on the first side) 101b of the lens 101. The state of being formed along the second surface 101b includes, to be specific, a state of being directly formed or applied above the second surface 101b of the lens 101 like the ¼ wavelength layer 121 of the above-described third embodiment and having a curvature radius equivalent to that of the second surface 101b at a front surface, and further includes a state of being disposed close to the second surface 101b with a slight interval so as not to change emission characteristics of image light in the Z direction and having the curvature radius equivalent to that of the second surface 101b at the front surface, a state where a thin layer structure such as the polarizing layer 111 is interposed between the ¼ wavelength layer 121 and the second surface 101b so as not to affect a phase difference of the image light in the Z direction as in the case of the ¼ wavelength layer 121 of the first embodiment and the second embodiment described above, and the curvature radius at the front surface is equivalent to that of the second surface 101b, or the like.

In addition, in the virtual image display device of the present disclosure, a second reflection layer or a reflection layer may be formed above the surface on the first side or the second side of the layer adjacent in the first direction as described in each of the embodiments described above, may be disposed close to the layer adjacent in the first direction with a slight interval therebetween, or a thin layer structure that does not affect the image light in unexpected optical characteristics may be interposed between the second reflection layer or the reflection layer and the layer adjacent in the first direction.

Although the preferred embodiments of the disclosure have been described in detail above, the disclosure is not limited to the particular embodiments, and various variations and changes are possible within the scope of the gist of the disclosure as described in the claims.

For example, the virtual image display device of each of the embodiments described above can be applied to a head mounted display device such as a head mounted display, and can be appropriately applied to an optical device other than the head mounted display device.

### Overview of Present Disclosure

An overview of the present disclosure is provided below as the appendices.

### Appendix 1

A virtual image display device that includes a display element configured to emit image light to a first side along a first direction, a first lens disposed farther on the first side than the display element and formed of a curved surface protruding toward the display element, a second lens that is disposed farther on the first side than the first lens, formed of a curved surface protruding toward the display element, and in which a curvature radius of a curved surface on the first side is larger than a curvature radius of a curved surface on a second side opposite to the first side in the first direction, a first polarizing layer disposed farther on the first side than the second lens, formed along the curved surface on the first side of the second lens, and configured to transmit a first polarized ray of incident light, and reflect a second polarized ray different from the first polarized ray of the incident light, a second polarizing layer disposed between the display element and the second lens in the first direction, and configured to transmit a first polarized ray of incident light, a first wavelength layer disposed between the second polarizing layer and the second lens in the first direction, formed along a curved surface on the first side of the first lens, and configured to impart, to incident light, a phase difference equivalent to ¼ of a wavelength of the light and transmit the incident light, a reflection layer disposed between the first wavelength layer and the second lens in the first direction, and configured to transmit a part of incident light, and reflect a remaining part of the incident light, and a second wavelength layer disposed between the reflection layer and the first polarizing layer in the first direction, formed along the curved surface on the first side of the first lens, and configured to impart, to incident light, a phase difference equivalent to ¼ of a wavelength of the light and transmit the incident light.

According to the configuration of Appendix 1, the virtual image display device is easy to be miniaturized and manufactured, and exhibits favorable telecentricity and, excellent optical characteristics at a wide visual field angle.

### Appendix 2

The virtual image display device according to Appendix 1, wherein
a refractive index of the second lens is higher than a refractive index of the first lens.

According to the configuration of Appendix 1, it is possible to reduce the entire device in thickness and increase a visual field angle.

### Appendix 3

The virtual image display device according to Appendix 1 or 2, wherein
the second polarizing layer, the first wavelength layer, the reflection layer, and the second wavelength layer are sequentially disposed toward the first side between the first lens and the second lens in the first direction.

According to the configuration of Appendix 3, it is possible to easily configure a telecentric optical system that is thin along the first direction and to obtain excellent optical characteristics at a wide visual field angle.

### Appendix 4

The virtual image display device according to Appendix 3, wherein
the first wavelength layer includes a first alignment film provided along a curved surface on the second side of the second lens, a sealing material disposed on the second side of the first alignment film and interposed from a front surface on the second side of the first alignment film to the second side to provide a certain interval, and a birefringent material filled in a space surrounded by the first alignment film and the sealing material, and aligned along a light distribution direction of the first alignment film.

According to the configuration of Appendix 4, it is possible to dispose the first wavelength layer having a less disturbance of a phase difference than an existing film-shaped wavelength plate or the like along the curved surface on the second side of the second lens which is a convex curved surface protruding toward the display element side. As a result, excellent optical characteristics are obtained and visibility of a virtual image is enhanced.

### Appendix 5

The virtual image display device according to Appendix 4, wherein
the second wavelength layer includes a second alignment film provided along the curved surface on the second side of the second lens, a sealing material disposed on the second side of the second alignment film and interposed from a front surface on the second side of the second alignment film to the second side to provide a certain interval, and a birefringent material filled in a region surrounded by the second alignment film and the sealing material, and aligned along a light distribution direction of the second alignment film.

According to the configuration of Appendix 5, it is possible to dispose the second wavelength layer having a less disturbance of a phase difference than an existing film-shaped wavelength plate or the like along the curved surface on the second side of the second lens. As a result, excellent optical characteristics are obtained and visibility of a virtual image is enhanced.

### Appendix 6

The virtual image display device according to any one of Appendixes 1 to 5, wherein
the first polarizing layer includes a first wire grid polarizer provided at the curved surface on the first side of the second lens, and a first base film covering the first wire grid polarizer from the first side.

According to the configuration of Appendix 6, a first modulation layer having a less variation in polarization characteristics than an existing film-shaped polarizing element can be disposed along the curved surface on the first side of the second lens recessed toward the display element side. As a result, excellent optical characteristics are obtained and visibility of a virtual image is enhanced.

### Appendix 7

The virtual image display device according to any one of Appendixes 1 to 6, wherein
the second polarizing layer includes a second wire grid polarizer provided at the curved surface on the first side of the first lens, and a second base film covering the second wire grid polarizer from the first side.

According to the configuration of Appendix 7, a second modulation layer having a less variation in polarization characteristics than an existing film-shaped polarizing element can be disposed along the curved surface on the first side of the first lens recessed toward the display element side. As a result, excellent optical characteristics are obtained and visibility of a virtual image is enhanced.

### Appendix 8

The virtual image display device according to Appendix 1 or 2, wherein
the second polarizing layer, the first wavelength layer, and the reflection layer are sequentially disposed between the first lens and the second lens toward the first side in the first direction, and the second wavelength layer is disposed between the second lens and the first polarizing layer in the first direction.

According to the configuration of Appendix 8, it is possible to easily configure a telecentric optical system that is thin along the first direction and to obtain excellent optical characteristics at a wide visual field angle.

### Appendix 9

The virtual image display device according to Appendix 1 or 2, wherein
the second polarizing layer is disposed between the display element and the first lens in the first direction, and the first wavelength layer and the reflection layer are sequentially disposed between the first lens and the second lens in the first direction toward the first side.

According to the configuration of Appendix 9, the second polarizing layer is disposed on the first side of the display element, a thin telecentric optical system is easily formed along the first direction, and excellent optical characteristics at a wide visual field angle can be obtained.

### Appendix 10

The virtual image display device according to Appendix 1 or 2, wherein
the first polarizing layer is formed above the curved surface on the first side of the second lens and is in contact with the curved surface on the first side of the second lens.

According to the configuration of Appendix 10, the virtual image display device can be further reduced in thickness. In addition, according to the configuration of Appendix 10, a polarized state of image light emitted from the second lens is less likely to be disturbed before being incident on the first polarizing layer, and excellent optical characteristics are obtained.

### Appendix 11

The virtual image display device according to Appendix 1 or 2, wherein
the second wavelength layer is formed above a curved surface on the second side of the second lens along the curved surface on the first side of the first lens and is in contact with the curved surface on the second side of the second lens.

According to the configuration of Appendix 11, the virtual image display device can be further reduced in thickness. In addition, according to the configuration of Appendix 11, a phase of image light is less likely to be disturbed before being incident on the second wavelength layer, and excellent optical characteristics are obtained.

### Appendix 12

The virtual image display device according to Appendix 1 or 2, wherein
the first wavelength layer is formed above the curved surface on the first side of the first lens and is in contact with the curved surface on the first side of the first lens.

According to the configuration of Appendix 12, a phase of image light including image light emitted from the first lens is less likely to be disturbed before being incident on the first wavelength layer, and excellent optical characteristics are obtained.

What is claimed is:

1. A virtual image display device, comprising:
a display element configured to emit image light;
a first lens including a first incident surface on which the image light emitted from the display element is incident and that protrudes toward the display element, and a first emission surface configured to emit the image light;
a second lens including a second incident surface on which the image light emitted from the first emission surface of the first lens is incident and that protrudes toward the display element, and a second emission surface that is larger than second incident surface in curvature radius and configured to emit the image light;
a first polarizing layer provided along, and disposed farther on a first side than the second emission surface of the second lens, formed along a curved surface on the first side of the second lens, and configured to transmit a first polarized ray of incident light and reflect a second polarized ray different from the first polarized ray of the incident light;
a second polarizing layer disposed between the display element and the second lens in a first direction that is a direction in which the first lens and the second lens are arranged, and configured to transmit a first polarized ray of incident light;
a first wavelength layer disposed between the second polarizing layer and the second lens in the first direction, and configured to impart, to incident light, a phase difference corresponding to ¼ of a wavelength of the light, and transmit the incident light;
a reflection layer disposed between the first wavelength layer and the second lens in the first direction, and configured to transmit a part of incident light, and reflect a remaining part of the incident light; and
a second wavelength layer disposed between the reflection layer and the first polarizing layer in the first direction, and configured to impart, to incident light, a phase difference corresponding to ¼ of a wavelength of the light and transmit the incident light.

2. The virtual image display device according to claim 1, wherein
a refractive index of the second lens is lower than a refractive index of the first lens.

3. The virtual image display device according to claim 1, wherein
the second polarizing layer, the first wavelength layer, the reflection layer, and the second wavelength layer are disposed between the first lens and the second lens in an order of the second polarizing layer, the first wavelength layer, the reflection layer, and the second wavelength layer toward the first side.

4. The virtual image display device according to claim 3, wherein
the first wavelength layer is provided above the reflection layer, and
the first wavelength layer includes a first alignment film, a first birefringent material provided between the first alignment film and the reflection layer in the first direction, and aligned along a light distribution direction of the first alignment film, and a first sealing material that seals the first birefringent material together with the first alignment film.

5. The virtual image display device according to claim 4, wherein
the second wavelength layer is provided at the second incident surface of the second lens, and
the second wavelength layer includes a second alignment film, a second birefringent material provided between the second alignment film and the second incident surface of the second lens in the first direction, and aligned along a light distribution direction of the second alignment film, and a second sealing material that seals the second birefringent material together with the second alignment film.

6. The virtual image display device according to claim 1, wherein
the first polarizing layer includes a first wire grid polarizer and a first base film, and
the first wire grid polarizer is provided between the second emission surface of the second lens and the first base film in the first direction.

7. The virtual image display device according to claim 1, wherein
the second polarizing layer includes a second wire grid polarizer and a second base film, and
the second wire grid polarizer is provided between the first emission surface of the first lens and the second base film in the first direction.

8. The virtual image display device according to claim 1, wherein
the second polarizing layer, the first wavelength layer, and the reflection layer are disposed between the first lens and the second lens in an order of the second polarizing layer, the first wavelength layer, and the reflection layer toward the first side, and
the second wavelength layer is disposed between the second lens and the first polarizing layer in the first direction.

9. The virtual image display device according to claim 1, wherein
the second polarizing layer is disposed between the display element and the first lens, and
the first wavelength layer and the reflection layer are sequentially disposed between the first lens and the second lens in an order of the first wavelength layer and the reflection layer.

10. The virtual image display device according to claim 1, wherein
the first polarizing layer is provided above the second emission surface of the second lens.

11. The virtual image display device according to claim 1, wherein
the second wavelength layer is provided above the second incident surface of the second lens.

12. The virtual image display device according to claim 1, wherein
the first wavelength layer is provided above the first emission surface of the first lens.
